(19) United States
(12) Patent Application Publication
(10) Pub. No.: US 2024/0426060 A1
(43) Pub. Date: Dec. 26, 2024

(54) METHOD FOR MANUFACTURING A MULTIPLY PAPERBOARD, AND A MULTIPLY PAPERBOARD

(71) Applicant: Stora Enso OYJ, Helsinki (FI)

(72) Inventor: Pasi Valkamo, Imatra (FI)

(73) Assignee: Stora Enso OYJ, Helsinki (FI)

(21) Appl. No.: 18/701,000

(22) PCT Filed: Oct. 12, 2022
(86) PCT No.: PCT/IB2022/059775

§ 371 Date: Apr. 12, 2024

(30) Foreign Application Priority Data
Oct. 13, 2021 (SE) 2151254-6

(51) Int. Cl. D21H 27/34; D21F 11/04; D21H 11/02; D21H 21/16; D21H 23/24; D21H 23/48; D21H 27/10; D21H 27/38

(52) U.S. Cl. CPC D21H 27/34; D21F 11/04; D21H 11/02; D21H 21/16; D21H 23/24; D21H 23/48; D21H 27/10; D21H 27/38

(57) ABSTRACT

The present invention relates to a method for manufacturing a multiply paperboard, comprising forming a first web on a first wire, a second web on a second wire and a third web on a third wire. The second web comprises a delamination web layer formed from a second pulp suspension comprising 5-80 weight-% refined CTMP and/or CMP. A first coating layer comprising 0.2-20 g/m² starch is applied to a non-wire side of the first web by curtain application. A second coating layer comprising 0.2-20 g/m² starch is applied to a non-wire side of the second web or the third web by curtain application. A multilayer web is formed by joining the third web with the second web via the second bonding layer and by joining the second web and the first web via the first bonding layer. The multilayer web is further dewatered and optionally dried to form the multiply paperboard. The invention relates also to a multiply paperboard.

### TECHNICAL FIELD

The present disclosure relates to a method for manufacturing a multiply paperboard for use in e.g. liquid packaging board, and a multiply paperboard for use in e.g. liquid packaging board. The multiply paperboard has improved delamination properties, creasability and crack resistance properties.

### BACKGROUND

Paperboard made from cellulosic fibers is used in many different applications, which have different specific requirements on the paperboard. Thus, there is a need that the properties of different paperboards are targeted depending on the intended end use. For example, paperboards may be used for graphical applications (brochures, book covers, etc.) or packaging applications. Typical packaging applications for paperboards are dry food (rice, cereal, etc.), liquids (milk, juice, hot liquids, etc.), tools (spare parts, etc.) cigarettes, pharmaceuticals, soap, etc.

Paperboard which is to be converted (e.g. coated, printed, cut, creased and folded) to packages or intermediates such as pre-creased blanks on fast running converting lines must have the required strength to withstand the strain and stress created during the converting. Thus, a basic requirement for a paperboard which is to be converted is a certain level of mechanical strength and stiffness, such as bending stiffness. High bending stiffness promotes good runnability on the packaging machine/converting line. Bending stiffness is also needed for the protection of the content of a package comprising a paperboard from the surrounding environments.

Generally, paperboard comprises one to five plies (layers) of pulp and optional additives. A paperboard that is to be converted usually comprises more than one ply. A multiply paperboard usually shows higher bending stiffness or enables higher stiffness design than a single-ply paperboard. The bending stiffness of a multiply paperboard is usually built up by having outer plies (top and back plies) with high tensile stiffness and one or more bulky plies in between (one or more middle plies), so that the outer plies are placed at a distance from each other.

Typically, the outer plies are made from chemical pulp, particularly softwood pulp, which has good strength properties. The chemical pulp also provides the outer plies with good printing properties. Hardwood pulp may also be added to the outer plies to improve the surface properties. Chemical pulp has high purity which is important in many applications.

The middle ply may contain mechanical pulp and/or chemical pulp. Mechanical pulp, such as groundwood, pressure groundwood, thermomechanical pulp (TMP), chemi-thermomechanical pulp (CTMP), alkaline peroxide mechanical pulp (APMP) and machine broke, is a desirable raw material, i.a. because it can be produced to a lower cost than chemical pulp. Also, mechanical pulp has a higher yield and thus a higher efficiency of raw material usage. Mechanical pulp or low refined chemical pulp is used in the middle ply for providing the highest possible bulk, i.e. for enabling formation of paperboard with high stiffness at low grammage. Typically, TMP and/or CTMP is/are used in the middle plies, possibly together with broke. During the recent years the use of softwood CTMP in the middle plies has increased because softwood CTMP in addition to high bulk also has long fibers, fines content and contact between fibers that can contribute to good internal bonding. Also, chemical pulp can be used in the middle ply in combination with mechanical pulp, as reinforcement, due to its high strength properties.

When the paperboard is creased, there are tensile, compression and shear forces acting on the paperboard. Cracking of the paperboard surface should be avoided and the cracking tendency is also affected by the paperboard structure. In order to minimize the cracking tendency, the stretch to break of the top ply should be as big as possible. Also, z-direction (thickness direction) strength is important. If the z-strength is too low, the paperboard can delaminate during subsequent converting operations. On the other hand, if the z-strength is too high, cracking can occur since the stretch is too big for the top ply.

When several wet webs or sheets are wet couched together, the weakest point of the paperboard is typically between different plies due to low fines content and more open structure in this point. This leads to a situation where the paperboard is delaminated between plies during creasing, thus causing imperfect crease which can lead to cracking during the converting operations.

In the prior art there are several ways to handle these problems.

One way to counteract the above problems is to increase the top and bottom ply grammage. In this way, top and bottom ply strength is increased which thus will counteract cracking tendency. However, the disadvantage with this is that cost increases due to increased chemical pulp usage and reduced bending stiffness, i.e. the structure is not optimized regarding bending stiffness.

Another way to counteract the above problems is to control the fines distribution. By controlling the fines retention and dewatering it might be possible to affect the strength properties. However, the disadvantage with this approach can be compromised productivity caused by reduced production output.

Still another way to counteract the above problems is to spray starch between the plies before couching the plies together. However, spray application of starch is usually performed using low viscosity liquids and results in a low solids content. Also, spray application of starch is causing a lot of dust and therefore contaminants and deposits and high risk for subsequent microbial growth in the paperboard environment. Dosing of dilute solutions to a paperboard web is not cost efficient and might lead to uneven distribution and unnecessary wetting.

Thus, there is still room for improvements of methods for the manufacturing of a multiply paperboard with decreased or limited cracking tendency and avoided or reduced delamination between the plies of the paperboard in converting operations.

### SUMMARY OF THE INVENTION

It is an object of the present invention to provide an improved method for manufacturing a multiply paperboard with decreased or limited cracking tendency and avoided or reduced delamination between the plies of the paperboard in converting operations, which method eliminates or alleviates at least some of the disadvantages of the prior art methods.

The above-mentioned objects, as well as other objects as will be realized by the skilled person in the light of the present disclosure, are achieved by the various aspects of the present disclosure.

According to a first aspect illustrated herein, there is provided a method for manufacturing a multiply paperboard, comprising the steps of:
a) forming a first web on a first wire and partially dewatering said first web on said first wire, wherein said first web comprises at least one first web layer formed from a first pulp suspension, wherein said first web has a wire side and a non-wire side;
b) forming a second web on a second wire and partially dewatering said second web on said second wire, wherein said second web comprises at least one second web layer formed from a second pulp suspension, wherein one second web layer of said at least one second web layer is a delamination web layer formed from a second pulp suspension comprising 5-80 weight-%, preferably 5-20 weight-%, refined pulp based on the total dry weight of total fiber content of the second pulp suspension, wherein the refined pulp is refined chemi-thermomechanical pulp (CTMP) and/or refined chemi-mechanical pulp (CMP), wherein said refined CTMP and said refined CMP, respectively, has a Schopper Riegler value (SR°) in the range of 20-40, preferably in the range of 25-40, wherein said second web has a wire side and a non-wire side;
c) forming a third web on a third wire and partially dewatering said third web on said third wire, wherein said third web comprises at least one third web layer formed from a third pulp suspension, wherein said third web has a wire side and a non-wire side
d) applying a first coating layer to said non-wire side of said first web, wherein said first coating layer comprises 0.2-20 g/m², preferably 0.5-15 g/m², most preferably 1.0-7.0 g/m², starch based on dry weight, wherein said first coating layer is applied by curtain application of at least one first coating suspension, wherein at least one of said at least one first coating suspension comprises starch;
e) applying a second coating layer to said non-wire side of said second web or to said non-wire side of said third web, wherein said second coating layer comprises 0.2-20 g/m², preferably 0.5-15 g/m², most preferably 1.0-7.0 g/m², starch based on dry weight, wherein said second coating layer is applied by curtain application of at least one second coating suspension, wherein at least one of said at least one second coating suspension comprises starch;
f) forming a multilayer web comprising:
   joining said third web with said second web such that said second coating layer is provided between said third web and said second web, and
   joining said first web with said second web such that said first coating layer is provided between said first web and said second web, and
g) further dewatering, and optionally drying, said multilayer web so as to provide said multiply paperboard, wherein said first web forms a first ply, said second web forms a second ply, said third web forms a third ply, said first coating layer forms a first bonding layer and said second coating layer forms a second bonding layer of said multiply paperboard after said dewatering, and optional drying, of said multilayer web.

It has surprisingly been found that by the combination of including an amount (5-80 weight-%) of refined CTMP and/or refined CMP as defined above in one second web layer (delamination layer) of the second web (second ply), a first coating layer (first bonding layer) comprising starch (0.2-20 g/m²) applied by curtain application between the first web (first ply) and the second web (second ply) and a second coating layer (second bonding layer) comprising starch (0.2-20 g/m²) applied by curtain application between the second web (second ply) and the third web (third ply), it is possible to produce a multiply paperboard with decreased or limited cracking tendency and avoided or reduced delamination between the plies of the paperboard in converting operations.

The introduction of the first and second bonding layers comprising the mentioned amount of starch applied by curtain application, implies that the bond between the plies is increased, i.e. the plies are tightly bound together. Curtain application of starch implies that a thin solid film (or coating or layer) may be obtained as a bonding layer. Compared to application of starch by spray coating according to the prior art, a much more coherent film (or coating) of starch may be obtained, i.e. a more even and covering coating of starch may be obtained by using curtain application. Accordingly, an increased bonding between plies may be obtained by using curtain application.

Thus, the introduction of the first and second bonding layers according to the present disclosure implies that the delamination between plies is avoided or reduced. This implies in turn that the strength from the complete paperboard is utilized against cracking contributing forces.

The use of an amount of refined CTMP and/or refined CMP as defined above in one second web layer (i.e. the delamination web layer) of the second web (second ply), implies that the delamination point or fracture point is controlled into the second ply structure, i.e. to the delamination layer, at the same time as a desired pore structure or permeability of the second ply may be maintained. The inclusion of the refined CTMP and/or refined CMP in the delamination layer implies that the strength of this layer is reduced, whereby the delamination/fracture may be controlled to this layer. The controlled delamination into the delamination layer of the second ply will contribute to good creasability and package forming, i.e. less stress towards packaging material is applied in e.g. folding phase.

Thus, as an outcome of the first and second bonding layers comprising starch as defined above, the robustness of the whole paperboard structure is increased by the enhanced support from the middle ply towards adjacent plies. The tightly bond multilayer structure can withstand the stresses applied in the creasing and folding substantially better compared to separated plies. Accordingly, the first and second bonding layers comprising starch as defined above is utilized against cracking. In addition, the inclusion of refined CTMP and/or refined CMP in a layer (i.e. the delamination layer) of the second ply facilitates/improves creasability.

The delamination position in the paperboard structure may be determined by a tester according to test method TAPPI/ANSI T 569 om-14. The two separate parts of the specimen are weighed, and the relative weight share is calculated. The weight share describes the delamination position in the structure. According to the present disclosure, the ideal position of the delamination inside the second ply may result in the weight range of 40-60%.

The paperboard of the present disclosure is a multiply paperboard comprising at least three plies, a first ply (which also may be referred to as a first outer ply), a second ply (which also may be referred to as an intermediate ply or mid ply) and a third ply (which also may be referred to as a second outer ply). In some embodiments, the first ply is a top ply and the third ply is a back ply. In other embodiments, the first ply is a back ply and the third ply is a top ply.

In some embodiments, the multiply paperboard comprises three plies, i.e. the first ply, the second ply and the third ply. However, the multiply paperboard of the present disclosure may also comprise further plies, such as one or more further intermediate plies, arranged as middle plies, between the first and second ply or between the second and third ply. Such further plies may comprise any kind of fibers or pulp combinations.

As mentioned above, the first web of the method of the first aspect forms a first ply, the second web forms a second ply, the third web forms a third ply, the first coating layer forms a first bonding layer and the second coating layer forms a second bonding layer of the multiply paperboard after the further dewatering, and optional drying, of the multilayer web.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements.

A paperboard-based packaging material is a single or multiply packaging material formed mainly, or entirely from paperboard. In addition to paperboard, the paperboard-based packaging material may comprise additional layers or coatings designed to improve the performance and/or appearance of the packaging material.

Paperboard machines for manufacturing multiply paperboard are well known in the art. The multiply paperboard of the present disclosure can be manufactured in a known paperboard machine adapted for manufacturing the multiply paperboard according to the present disclosure. Typically, the machine layout of known paperboard machines comprises a stock handling section, a wet end section, a pressing and drying section and optionally a calendering and/or coating section. In the wet end section of a paperboard machine adapted for manufacturing the multiply paperboard of the present disclosure, the plies are formed individually on respective wires using different headboxes and laminated (wet couched) in a wet state. Typically, the plies are laminated before the pressing and drying section of the paperboard machine. Also, the wet end section of a paperboard machine adapted for manufacturing the multiply paperboard of the present disclosure comprises curtain applicator equipment for providing the first coating layer and the second coating layer.

In some embodiments, the grammage of each of the first ply, the second (intermediate) ply and the third ply is in the range of 30-200 g/m², preferably in the range of 40-150 g/m². The total grammage of the multiply paperboard is preferably in the range of 100-500 g/m².

In some embodiments, the multiply paperboard of the present disclosure is a multiply paperboard for liquid packaging, i.e. for packaging of liquids (e.g. milk, juice, hot liquids, etc.), such as a liquid packaging board. The liquid packaging board may comprise or consist of three plies, i.e. the first ply, the second ply and the third ply of the present disclosure.

As mentioned above, step a) of the method of the first aspect comprises forming a first web on a first wire and partially dewatering the first web on the first wire. The first web comprises at least one first web layer (i.e. sub-layer) formed from a first pulp suspension. Thus, in some embodiments the first web consists of (i.e. is constituted by) one first web layer formed from a first pulp suspension by a single layer headbox on the first wire. However, in some embodiments, the first web consists of two or more first web layers formed together by a multiply headbox on the first wire. Each first web layer of these embodiments is formed from a first pulp suspension, i.e. an associated/respective first pulp suspension. The respective first pulp suspensions for forming the two or more first web layers of these embodiments may have the same composition or different compositions.

Each first pulp suspension may comprise chemical pulp, particularly softwood pulp, which has good strength properties. The chemical pulp also provides the ply formed from the first pulp suspension(s) with good printing properties. Hardwood pulp may also be included in the first pulp suspension to improve the surface properties. Chemical pulp has a high purity which is important in many applications. The chemical pulp may be bleached or unbleached pulp.

Each first pulp suspension may have any composition suitable for forming a web layer to be part of a web forming an outer ply, i.e. a back ply or a top ply, after dewatering and optional drying. For example, each first pulp suspension may comprise 0-100 weight-% hardwood chemical pulp (bleached or unbleached) and 0-100 weight-% softwood chemical pulp (bleached or unbleached) based on the total dry weight of total fiber content of the first pulp suspension. One or more first pulp suspensions can also comprise other fibers such as CTMP or broke.

As mentioned above, the first web comprises a wire side and a non-wire side (opposite side). As also mentioned above, the first web forms a first ply (which also may be referred to as a first outer ply) after dewatering and optional drying, wherein the wire side of the first web may form an outer surface of the first ply. The term “wire side” of the first web is herein intended to mean the side of the first web positioned adjacent (in contact with) the first wire after forming on the first wire. The term “non-wire side” of the first web is herein intended to mean the side of the first web positioned opposite the wire side, i.e. the side of the first web not positioned in contact with the first wire after forming on the first wire. However, in embodiments involving two-sided dewatering the non-wire side of the first web may be brought in contact with another wire than the first wire.

As mentioned above, step b) of the method of the first aspect comprises forming a second web on a second wire and partially dewatering the second web on the second wire. The second web comprises at least one second web layer (i.e. sub-layer) formed from a second pulp suspension. Thus, in some embodiments the second web consists of (i.e. is constituted by) one second web layer formed from a second pulp suspension by a single layer headbox on the second wire. However, in some embodiments, the second web consists of two or more second web layers formed together by a multiply headbox on the second wire. Each second web layer of these embodiments is formed from a second pulp suspension, i.e. an associated/respective second pulp suspension. The respective second pulp suspensions for forming the two or more second web layers may have the same composition or different compositions.

As mentioned above, the second web comprises a wire side and a non-wire side (opposite side). The wire side of the second web is preferably arranged to be positioned adjacent to the non-wire side of the first web (i.e. with the first coating layer in between the wire side of the second web and the non-wire side of the first web) after wet couching. The non-wire side of the second web is preferably arranged to be positioned adjacent to the non-wire side of the third web (i.e. with the second coating layer in between the non-wire side of the second web and the non-wire side of the third web). The term “wire side” of the second web is herein intended to mean the side of the second web positioned adjacent (in contact with) the second wire after forming on the second wire. The term “non-wire side” of the second web is herein intended to mean the side of the second web positioned opposite the wire side, i.e. the side of the second web not positioned in contact with the second wire after forming on the second wire. However, in embodiments involving two-sided dewatering the non-wire side of the second web may be brought in contact with another wire than the second wire.

According to the present disclosure, one second web layer of the at least one second web layer of the second web is a delamination web layer formed from a second pulp suspension comprising 5-80 weight-%, preferably 5-20 weight-%, refined pulp based on the total dry weight of total fiber content of the second pulp suspension, wherein the refined pulp is refined chemi-thermomechanical pulp (CTMP) and/or refined chemi-mechanical pulp (CMP). The refined CTMP and the refined CMP, respectively, has a Schopper Riegler value (SR°) in the range of 20-40, preferably in the range of 25-40, as determined by standard ISO 5267-1. The SR value is determined for a pulp without additional chemicals. The CTMP may be bleached or unbleached. The CMP may be bleached or unbleached.

In some embodiments, the refined pulp consists of CTMP. In some embodiments, the refined pulp consists of CMP. In some embodiments, the refined pulp consists of CTMP and CMP.

The terms “refined CTMP” (or “post-refined CTMP”) and “refined CMP” (or “post-refined CMP”) are herein intended to mean CTMP and CMP, respectively, which has been subjected to a refining step (post-refining step) to produce refined (post- refined) CTMP and CMP, respectively, having a certain Schopper Riegler value, i.e. a Schopper Riegler value (SR°) in the range of 20-40, preferably in the range of 25-40, as determined by standard ISO 5267-1. The refining step may be performed after the production of the CTMP and the CMP, respectively, or in connection with the production of the never-dried CTMP and CMP, respectively. Typically, the CTMP and the CMP, respectively, has already passed a high consistency refining and defibrillation step before the production of the “refined CTMP” and “refined CMP”, respectively. The production of “refined CTMP” and “refined CMP”, respectively, is a low consistency or medium consistency refining. Possibly, it is an accept that is refined to produce the refined CTMP or refined CMP. Thus, the refining step may be performed in connection with the paperboard mill process for manufacturing the paperboard according to the present disclosure. Alternatively, the refining step may be performed as a part of, or extension of, the CTMP and the CMP manufacturing process after CTMP and CMP, respectively, has been manufactured. Typically, normal CTMP and CMP (i.e. non-refined) has SR values of <20 SR°. The refining may be performed with any suitable refining equipment, for example a disk refiner or a conical refiner.

In some embodiments, the refined CTMP and/or the refined CMP has a Canadian

Standard Freeness (CSF) value of 300-600 ml, preferably 300-550 ml, measured according to ISO 5267-2:2001.

The second pulp suspension for forming the delamination web layer may in addition to the refined CTMP and/or refined CMP comprise mechanical pulp and/or chemical pulp, typically thermomechanical pulp (TMP) and/or (non-refined) chemi-thermomechanical pulp (CTMP) and/or (non-refined) chemi-mechanical pulp (CMP) for providing a high bulk. For example, the second pulp suspension for forming the delamination web layer may in addition to the refined CTMP and/or refined CMP comprise 0-80 weight-% TMP and/or 0-80 weight-% chemical hardwood and/or softwood pulp (bleached or unbleached) and 0-50 weight-% broke based on the total dry weight of total fiber content of the second pulp suspension.

Thus, as mentioned above, the second web according to the present disclosure comprises one second web layer, which is the delamination web layer, formed from a second pulp suspension comprising the above specified refined CTMP and/or refined CMP. Accordingly, in some embodiments, the second web consists of one second web layer, which is the delamination web layer, (and thereby no further second web layers). In other embodiments, the second web consists of the second web layer being the delamination web layer and one or more further second web layers, which is/are not formed from the second pulp suspension for forming the delamination web layer. The one or more further second web layer is formed from second pulp suspension(s) different from the second pulp suspension for forming the delamination web layer. The one or more further second web layers does/do not constitute delamination web layer(s). The one or more further second web layers may be formed from second pulp suspensions comprising mechanical pulp and/or chemical pulp, typically thermomechanical pulp (TMP) and/or (non-refined) chemi-thermomechanical pulp (CTMP) and/or (non-refined) chemi-mechanical pulp (CMP) for providing a high bulk. The second pulp suspension(s) for forming the one or more further second web layers may further comprise refined CTMP and/or refined CMP as defined above, but a lower portion of refined CTMP and CMP and/or CTMP and CMP with a lower SR value compared to the second pulp suspension for forming the delamination web layer.

As mentioned above, step c) of the method of the first aspect comprises forming a third web on a third wire and partially dewatering the third web on the third wire. The third web comprises at least one third web layer (sub-layer) formed from a third pulp suspension. Thus, in some embodiments the third web consists of (i.e. is constituted by) one third web layer formed from a third pulp suspension by a single layer headbox on the third wire. However, in some embodiments, the third web consists of two or more third web layers formed together by a multiply headbox on the third wire. Each third web layer of these embodiments is formed from a third pulp suspension, i.e. an associated/respective third pulp suspension. The respective third pulp suspensions for forming the two or more third web layers may have the same composition or different compositions.

Each third pulp suspension may comprise chemical pulp, particularly softwood pulp, which has good strength properties. The chemical pulp also provides the ply formed from the third pulp suspension(s) with good printing properties. Hardwood pulp may also be included in the third pulp suspension to improve the surface properties. Chemical pulp has a high purity which is important in many applications. The chemical pulp may be bleached or unbleached.

Each third pulp suspension may have any composition suitable for forming a web layer to be part of a web forming an outer ply, i.e. a top ply or a back ply, after dewatering and optional drying. For example, each third pulp suspension may comprise 0-100 weight-% chemical pulp (bleached or unbleached) and/or 0-100 weight-% mechanical or thermomechanical pulp (bleached or unbleached) based on the total dry weight of total fiber content of the third pulp suspension. One or more third pulp suspensions can also comprise other fibers such as CTMP or broke.

As mentioned above, the third web comprises a wire side and a non-wire side (opposite side). As also mentioned above, the third web forms a third ply (which also may be referred to as a second outer ply) after dewatering and optional drying, wherein the wire side of the third web may form an outer surface of the third ply. The term “wire side” of the third web is herein intended to mean the side of the third web positioned adjacent (in contact with) the third wire after forming on the third wire. The term “non-wire side” of the third web is herein intended to mean the side of the third web positioned opposite the wire side, i.e. the side of the third web not positioned in contact with the third wire after forming on the third wire. However, in embodiments involving two-sided dewatering the non-wire side of the third web may be brought in contact with another wire than the third wire.

In some embodiments, the first web consists of one first web layer, the second web consists of one second web layer being the delamination web layer and the third web consists of one third web layer.

As mentioned above, step d) of the method of the first aspect comprises applying a first coating layer to the non-wire side of the first web. The first coating layer may be applied during or after the partial dewatering of the first web, such as when the first web is positioned on the first wire. The applied first coating layer comprises, i.e. has a coat weight of, 0.2-20 g/m², preferably 0.5-15 g/m², most preferably 1.0-7.0 g/m², starch based on dry weight. The first coating layer is applied by curtain application (curtain coating) of at least one first coating suspension. At least one of the at least one first coating suspension comprises starch so that the above mentioned starch coat weight is obtained. Preferably, each first coating suspension is an aqueous suspension.

Accordingly, the first coating layer may be formed by applying one or more first coating suspensions by curtain application. In some embodiments, one first coating suspension is applied by curtain application for forming the first coating layer. In these embodiments, the first coating suspension may comprise 50-100 weight-%, preferably 60-100 weight-%, most preferably 70-100 weight-%, starch based on total dry solids content of the first coating suspension.

In some embodiments, two or more first coating suspensions are applied by curtain application for forming the first coating layer. In these embodiments, the first coating suspensions may have the same or different compositions. For example, one of the first coating suspensions may comprise starch so that the above mentioned starch coat weight is obtained, wherein the first coating suspension may comprise 50-100 weight-%, preferably 60-100 weight-%, most preferably 70-100 weight-%, starch based on total dry solids content of the first coating suspension. Alternatively, more than one or all of the first coating suspensions may comprise starch so that the above mentioned starch coat weight is obtained.

In embodiments involving application of two or more first coating suspensions for forming the first coating layer, the first coating suspensions may be applied by multilayer curtain application (curtain coating) and/or by curtain application at different stations or positions on the first wire. Thus, in these embodiments, the first coating layer is applied by curtain application of at least two first coating suspensions by multilayer curtain application and/or single layer curtain application at one or more curtain application stations so that two or more first sub-layers are applied, wherein the two or more first sub-layers constitutes/forms the first coating layer.

In some embodiments, the curtain application of starch of the first coating layer is combined with additional spray application of starch.

As mentioned above, step e) of the method of the first aspect comprises applying a second coating layer to the non-wire side of the second web or the non-wire side of the third web. The second coating layer may be applied during or after the partial dewatering of the second web and third web, respectively, such as when the second web and the third web is positioned on the second wire and the third wire, respectively. The applied second coating layer comprises, i.e. has a coat weight of, 0.2-20 g/m², preferably 0.5-15 g/m², most preferably 1.0-7.0 g/m², starch based on dry weight. The second coating layer is applied by curtain application (curtain coating) of at least one second coating suspension. At least one of the at least one second coating suspension comprises starch so that the above mentioned starch coat weight is obtained. Preferably, each second coating suspension is an aqueous suspension.

Thus, in some embodiments, the second coating layer is applied to the non-wire side of the second web. In some embodiments, the second coating layer is applied to the non-wire side of the third web.

Accordingly, the second coating layer may be formed by applying one or more second coating suspensions by curtain application. In some embodiments, one second coating suspension is applied by curtain application for forming the second coating layer. In these embodiments, the second coating suspension may comprise 50-100 weight-%, preferably 60-100 weight-%, most preferably 70-100 weight-%, starch based on total dry solids content of the second coating suspension.

In some embodiments, two or more second coating suspensions are applied by curtain application for forming the second coating layer. In these embodiments, the second coating suspensions may have the same or different compositions. For example, one of the second coating suspensions may comprise starch so that the above mentioned starch coat weight is obtained, wherein the second coating suspension may comprise 50-100 weight-%, preferably 60-100 weight-%, most preferably 70-100 weight-%, starch based on total dry solids content of the second coating suspension. Alternatively, more than one or all of the second coating suspensions may comprise starch so that the above mentioned starch coat weight is obtained.

In embodiments involving application of two or more second coating suspensions for forming the second coating layer, the second coating suspensions may be applied by multilayer curtain application (curtain coating) and/or by curtain application at different stations or different positions on the second wire. Thus, in these embodiments, the second coating layer is applied by curtain application of at least two second coating suspensions by multilayer curtain application and/or single layer curtain application at one or more curtain application stations so that two or more second sub-layers are applied, wherein the two or more second sub-layers constitutes/forms the second coating layer.

In some embodiments, the curtain application of starch of the second coating layer is combined with additional spray application of starch.

The curtain application of step d) and step e) of the method of the first aspect may be performed by any suitable curtain application (curtain coating) equipment, such as e.g. a slot die system, a flex jet system or slide jet systems. The curtain application (curtain coating) equipment may be a single layer or multilayer curtain applicator equipment. In some embodiments, at least one of the at least one first coating suspension and/or at least one of the at least one second coating suspension is provided in the form of a foam and applied in the form of the foam by the curtain application. During dewatering the foam will go extinct. For example, the curtain application equipment may be positioned such that the distance between a curtain applicator nozzle/outlet (or nozzles/outlets) and the wet web is 1-500 mm, preferably 1-300 mm.

In some embodiments, the curtain application is performed at a position at which there is a vacuum box beneath or associated with the respective web to which the first coating suspension(s) and/or the second coating suspension(s) is to be applied. Preferably, the curtain application is performed in the beginning of a vacuum box area as seen in the machine direction.

In some embodiments, the starch of at least one first coating suspension of the at least one first coating suspension comprising starch is in the form of starch particles or in the form of a mixture of starch particles and cooked starch. In some embodiments, the starch of all first coating suspensions comprising starch is in the form of starch particles or in the form of a mixture of starch particles and cooked starch. In some embodiments, the starch of at least one second coating suspension of the at least one second coating suspension comprising starch is in the form of starch particles or in the form of a mixture of starch particles and cooked starch. In some embodiments, the starch of all second coating suspensions comprising starch is in the form of starch particles or in the form of a mixture of starch particles and cooked starch.

In embodiments comprising use of more than one first coating suspension comprising starch for forming the first coating layer, the first coating suspensions comprising starch may comprise different or the same amounts of starch, different or the same forms of starch and different or the same ratios of different forms of starch. Likewise, in embodiments comprising use of more than one second coating suspension comprising starch for forming the second coating layer, the second coating suspensions comprising starch may comprise different or the same amounts of starch, different or the same forms of starch and different or the same ratios of different forms of starch. Furthermore, the at least one first coating suspension comprising starch may comprise different amounts of starch and/or different forms of starch and/or mixtures of different ratios with different forms of starch compared to the at least one second coating suspension comprising starch.

In some embodiments, the starch of at least one first coating suspension of the at least one first coating suspension comprising starch is in the form of starch particles of uncooked native starch. In some embodiments, the starch of all first coating suspensions comprising starch is in the form of starch particles of uncooked native starch. In some embodiments, the starch of at least one second coating suspension of the at least one second coating suspension comprising starch is in the form of starch particles of uncooked native starch. In some embodiments, the starch of all second coating suspensions comprising starch is in the form of starch particles of uncooked native starch.

The term starch as used herein refers to starch derived of plant material that is usually used in the papermaking industry and which may be rise, barley, wheat, potato, maize, or tapioca starch. The term starch particles refers to starch that has not been cooked for full dissolution, i.e. to soluble and polymeric form, but is in its native, pre-gelatinized or partly gelatinized granular form. Such “uncooked” or partly uncooked starch contains particulate starch material that can be identified e.g. with a microscope. The term uncooked starch means that the starch has not been cooked, so that the main fraction of starch particles is visible in an optical light microscope. Even starch in its unmodified and uncooked form tends to swell, especially if stored at higher pH or elevated temperature. That means, also uncooked starch may be swollen to some extent. Therefore, the term starch particles as used herein also includes gelled starch or swollen starch. All forms of swelling and native particles can be identified with an optical microscope, preferably under polarized light. Starch particle size can be determined e.g. with laser light scattering or low angle laser light scattering. One example is a Mastersizer 2000 particle size analyser (Malvern, UK), which measures the percentage of the total starch volume for a given diameter size interval. Other methods to determine the average particle size are e.g. optical image analysis.

In some embodiments, there is a temperature difference between the at least one first coating suspension comprising starch and the wet web to which it is applied and/or between the at least one second coating suspension comprising starch and the wet web to which it is applied, wherein the temperature of the wet web is higher than the suspension(s) and wherein the temperature difference is 5-90° C., preferably 30-50° C. However, in some embodiments, there is no temperature difference between the at least one first coating suspension comprising starch and the wet web to which it is applied and/or between the at least one second coating suspension comprising starch and the wet web to which it is applied.

In some embodiments, the first coating layer further comprises 0.1-15 g/m², preferably 0.5-10 g/m², most preferably 0.7-7 g/m², microfibrillated cellulose (MFC) based on dry weight. In some embodiments, the second coating layer further comprises 0.1-15 g/m², preferably 0.5-10 g/m², most preferably 0.7-7 g/m², microfibrillated cellulose based on dry weight. In some embodiments, the first coating layer and the second coating layer, respectively, comprises 0.1-15 g/m², preferably 0.5-10 g/m², most preferably 0.7-7 g/m², microfibrillated cellulose based on dry weight. Thus, in these embodiments, at least one first coating suspension used for forming the first coating layer and/or at least one second coating suspension used for forming the second coating layer comprises MFC so as to obtain the mentioned amounts of MFC in the first coating layer and/or the second coating layer.

Preferably, the amount of MFC is less than the amount of starch in the first coating layer and the second coating layer, e.g. the amount of MFC is at least 10% or 20% or 30% less than the amount of starch.

Microfibrillated cellulose (MFC) shall in the context of this patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

One or more of the first coating suspensions used for forming the first coating layer and/or one or more of the second coating suspensions used for forming the second coating layer may further comprise at least one further component selected from the group of: rheology modifiers, cross-linkers, pH regulators, dispersing agents, biocides, defoaming agents, reinforcement agents, pigments, wood fiber fines, fillers and dyes.

In some embodiments, the first coating layer consists of starch. In some embodiments, the first coating layer consists of starch and at least one further component selected from the group of: rheology modifiers, cross-linkers, pH regulators, dispersing agents, biocides, defoaming agents, reinforcement agents, pigments, wood fiber fines, fillers and dyes. In some embodiments, the first coating layer comprises 60-100% starch, preferably 80-100% starch, based on dry weight.

In some embodiments, the second coating layer consists of starch. In some embodiments, the second coating layer consists of starch and at least one further component selected from the group of: rheology modifiers, cross-linkers, pH regulators, dispersing agents, biocides, defoaming agents, reinforcement agents, pigments, wood fiber fines, fillers and dyes. In some embodiments, the second coating layer comprises 60-100% starch, preferably 80-100% starch, based on dry weight.

In some embodiments, the first coating layer and the second coating layer, respectively, does not comprise any MFC.

In some embodiments, the at least one first coating suspension used for forming the first coating layer (step d)) is applied to the non-wire side of the first web when the first web has a dry content of 3-20 weight-%, preferably 5-15 weight-%, or after the water line. In some embodiments, the at least one second coating suspension used for forming the second coating layer (step e)) is applied to the non-wire side of the second web or the non-wire side of the third web when the second web or the third web has a dry content of 3-20 weight-%, preferably 5-15 weight-%, or after the water line.

As mentioned above, step f) of the method of the first aspect comprises forming a multilayer web comprising:
joining the third web with the second web such that the second coating layer is provided between the third web and the second web, and
joining the first web with the second web such that the first coating layer is provided between the first web and the second web.

Thus, in step f) the webs are joined and bonded together by the first coating layer and the second coating layer so as to form a multilayer web, i.e. a web comprising the first web, the second web and the third web, wherein the first web is joined with the second web via the first coating layer and the second web is joined with the third web via the second coating layer.

The joining of the webs may be performed by wet couching or wet lamination. When the pulp suspension is dewatered on the wire a visible boundary line will appear at a point where the web goes from having a reflective water layer to where this reflective layer disappears. This boundary line between the reflective and non-reflective web is referred to as the waterline. The waterline is indicative of a certain solids content of the web. The webs are preferably joined after the water line. The joining can be achieved by applying one of the webs on top of the other.

Joining and further dewatering of the formed multilayer web may be improved by various additional operations. In some embodiments, the joining further comprises pressing the webs together. In some embodiments, the joining further comprises applying suction to the joined webs. Applying pressure and/or suction to the formed multilayer web improves adhesion between the webs. Steam may also be added, which will aid the starch to soften and plasticize. The wire section of a paperboard machine may have various dewatering devices such as blade, table and/or foil elements, suction boxes, friction less dewatering, ultra-sound assisted dewatering, couch rolls, or a dandy roll. The dewatering can also be two-sided, i.e. part of the water is drained from both sides.

As mentioned above, step g) of the method of the first aspect comprises further dewatering, and optionally drying, the multilayer web formed in step f) so as to provide the multiply paperboard. The first web forms a first ply, the second web forms a second ply, the third web forms a third ply, the first coating layer forms a first bonding layer (first tie layer) and the second coating layer forms a second bonding layer (second tie layer) of the multiply paperboard after the dewatering, and optional drying, of the multilayer web.

In some embodiments, the first bonding layer and the second bonding layer, respectively, has a density of 0.8-1.5 kg/m³, such as 0.9-1.4 kg/m³.

In some embodiments, the first web constitutes a top web, the first ply constitutes a top ply, the third web constitutes a back web and the third ply constitutes a back ply.

In some embodiments, the first web constitutes a back web, the first ply constitutes a back ply, the third web constitutes a top web and the third ply constitutes a top ply.

In the further dewatering and optional drying step g), the dry solids content of the multilayer web is typically further increased. The resulting multiply paperboard preferably has a dry solids content above 80 weight-%, more preferably above 85 weight-%, most preferably 90-99 weight-%, such as 91-99 weight-% or 92-98 weight-%.

The further dewatering typically comprises pressing the multilayer web to squeeze out as much water as possible. The further dewatering may for example include passing the formed multilayer web through a press section of a paperboard machine, where the multilayer web passes between large rolls loaded under high pressure to squeeze out as much water as possible. The removed water is typically received by a fabric or felt or e.g. a shoe press or extended nips.

The optional drying may for example include drying the multilayer web by passing the multilayer web around a series of heated drying cylinders or extended nip or belt driers. It is also possible to use radiation curing or impingement driers.

In some embodiments, the non-wire side of the second web is further dewatered by a further dewatering equipment during or after the partial dewatering on the second wire, wherein a further wire of the further dewatering equipment may be positioned in contact with the non-wire side of the second web.

In some embodiments, the third web (i.e. the non-wire side of the third web) is joined with the second web before the first web (i.e. the coated non-wire side of the first web) is joined with the second web. Alternatively, the first web (i.e. the coated non-wire side of the first web) is joined with the second web before the third web is joined with the second web.

In some embodiments, the first web is joined with the second web before the non-wire side of the second web is provided with the second coating layer. Thus, in these embodiments the second coating layer is applied to the non-wire side of the second web when the second web already is joined with the first web. The third web is joined with the second web after application of the second coating layer.

The first coating layer may be applied as a wet continuous or non-continuous film or coating and/or the second coating layer may be applied as a wet continuous or non-continuous film or coating.

In some embodiments, the multiply paperboard is coated or laminated with at least one barrier layer on at least one side. The paperboard can be e.g. on-line or off-line coated with one or several layers such as surface size following one or several barrier layers. Example of surface size is e.g. polysaccharides such as starch, carboxymethyl cellulose (CMC), hemicellulose, protein or synthetic water soluble polymers such as polyvinyl alcohol or polyvinyl acetate/alcohol or modified versions thereof, S/A latexes, acrylic copolymers, etc. Before applying a barrier coating, it is also possible to apply a mineral coating onto the paperboard. A mineral coating forming a printing surface on top of the barrier coating may also or alternatively be applied. Furthermore, the paperboard can be extrusion coated or laminated with one or several layers of polyolefin or polyesters in order to provide e.g. liquid, gas, grease, aroma, vapor barriers and/or other performance properties such as heat sealability.

According to a second aspect of the present disclosure there is provided a multiply paperboard obtainable by the method of the first aspect.

According to a third aspect of the present disclosure there is provided a multiply paperboard comprising a first ply, a second ply and a third ply, wherein a first bonding layer is provided between the first ply and the second ply, wherein a second bonding layer is provided between said second ply and said third ply, wherein said second ply comprises at least one second ply layer, wherein one second ply layer of said at least one second ply layer is a delamination layer comprising 5-80 weight-%, preferably 5-20 weight-%, refined pulp based on the total dry weight of total fiber content of the second ply layer, wherein the refined pulp is chemi-thermomechanical pulp (CTMP) and/or refined chemi-mechanical pulp (CMP), wherein said refined CTMP and said refined CMP has a Schopper Riegler value (SR°) in the range of 20-40, preferably in the range of 25-40, wherein said first bonding layer and said second bonding layer, respectively, comprises 0.2-20 g/m², preferably 0.5-15 g/m², most preferably 1.0-7.0 g/m², starch based on dry weight.

In some embodiments, the refined CTMP and/or the refined CMP of the multiply paperboard has a Canadian Standard Freeness (CSF) value of 300-600 ml, preferably 300-550 ml, measured according to ISO 5267-2:2001.

In some embodiments, the multiply paperboard has a Scott bond value in the range of 80-500 J/m². The Scott bond value as expressed herein is measured in accordance with Tappi 569.

In some embodiments, the multiply paperboard has a Z-strength value in a range of 100-500 kPa. The Z-strength value as expressed herein is measured in accordance with SCAN P 80:98.

In some embodiments, the multiply paperboard has a grammage of 100-500 gsm. The grammage as expressed herein is measured in accordance with ISO 536.

In some embodiments, the multiply paperboard is coated with at least one barrier layer on at least one side.

In some embodiments, the multiply paperboard is or is comprised in a paperboard for liquid packaging.

In some embodiments, the multiply paperboard is a folding box board.

The multiply paperboard may further be defined as set out above with reference to the method of the first aspect.

According to a fourth aspect of the present disclosure, there is provided use of the multiply paperboard according to the second or third aspect in paperboard for liquid packaging.

In view of the above detailed description of the present invention, other modifications and variations will become apparent to those skilled in the art. However, it should be apparent that such other modifications and variations may be effected without departing from the spirit and scope of the invention.

### EXAMPLES

### Example 1 (Comparative)

A 3-ply paperboard with top ply (i.e., the first ply typically comprising bleached kraft pulp), mid ply (i.e., the second ply typically comprising unbleached kraft pulp), and back ply (i.e., the third ply typically comprising unbleached kraft pulp) was prepared with a native starch (uncooked) sprayed between the first and second ply. The physical properties and delamination behaviour are shown in Table 1 below. The delamination deviates from the targeted 50% center line towards the top ply.

### Example 2

Example 2 is a trial corresponding to Example 1. The same 3-ply paperboard structure was utilized in Example 2 as in Example 1, but 25 wt % post refined CTMP was included in the mid ply (based on dry weight of the mid ply) of Example 2. The post refined CTMP had a Canadian Standard Freeness (CSF) value of 530 ml, measured according to ISO 5267-2:2001, (which corresponds to a Schopper Riegler (°SR) value of about 21). Furthermore, in Example 2 native uncooked starch was applied between the top ply and the mid ply and between the mid ply and the back ply, respectively, using a curtain applicator (instead of spray starch as in Example 1). The results show that although the CTMP was post refined and provided a higher z-strength value, (which is ascribed to higher internal strength), the delamination point was actually in the midpoint. This confirms that the invention allows for the use of post refined CTMP according to the refining level as mentioned in the application, whereas the starch applied between the plies provides a strength which controls the delamination point to the splitting point target of 50% without compromising the z-strength or enabling further enhancing the thickness directional strength in the whole board structure.

TABLE 1

| | Unit | Standard | Example 1 | Example 2 |
|---|---|---|---|---|
| Grammage | g/m² | ISO 536 | 258 | 252 |
| CTMP refining | CSF, ml | ISO 5267-1 | — | 530 |
| CTMP in mid ply | % | | — | 25 |
| Starch (Spray) | g/m² | | 2 + 0 | — |
| between plies | | | | |
| 1&2 + 2&3 | | | | |
| Starch (curtain) | g/m² | | — | 2 + 2 |
| Z-strength | kPa | SCAN P 80:98 | 337 | 345 |
| Delamination % | % (top | TAPPI/ANSI T 569 | 47.5 | 49.9 |
| | share) | om-14 | | |

The splitting point was determined by delaminating the samples by Ply Bond tester (TAPPI/ANSI T 569 om-14) and then evaluation by visual inspection and by 5 gravimetric means (%). The top share represents the amount (%) of the top ply side when splitting the specimen into 2 sheets. The closer the value is to 50% the more controlled the splitting behaviour inside the mid ply is.

1. A method for manufacturing a multiply paperboard, comprising the steps of:
a) forming a first web on a first wire and partially dewatering said first web on said first wire, wherein said first web comprises at least one first web layer formed from a first pulp suspension, wherein said first web has a wire side and a non-wire side;
b) forming a second web on a second wire and partially dewatering said second web on said second wire, wherein said second web comprises at least one second web layer formed from a second pulp suspension, wherein one second web layer of said at least one second web layer is a delamination web layer formed from a second pulp suspension comprising 5-80 weight-% refined pulp based on a total dry weight of total fiber content of the second pulp suspension, wherein the refined pulp is refined chemi-thermomechanical pulp (CTMP), or refined chemi-mechanical pulp (CMP), or a combination thereof, wherein said refined CTMP and said refined CMP, respectively, has a Schopper Riegler value (SR°) in the range of 20-40, wherein said second web has a wire side and a non-wire side;
c) forming a third web on a third wire and partially dewatering said third web on said third wire, wherein said third web comprises at least one third web layer formed from a third pulp suspension, wherein said third web has a wire side and a non-wire side d) applying a first coating layer to said non-wire side of said first web, wherein said first coating layer comprises 0.2-20 g/m², starch based on a dry weight, wherein said first coating layer is applied by curtain application of one or more first coating suspensions, wherein at least one of said one or more first coating suspensions comprises starch;
e) applying a second coating layer to said non-wire side of said second web or to said non-wire side of said third web, wherein said second coating layer comprises 0.2-20 g/m² starch based on a dry weight, wherein said second coating layer is applied by curtain application of one or more second coating suspensions, wherein at least one of said one or more second coating suspensions comprises starch;
f) forming a multilayer web by:
joining said third web with said second web such that said second coating layer is provided between said third web and said second web, and
joining said first web with said second web such that said first coating layer is provided between said first web and said second web, and
g) further dewatering, and optionally drying, said multilayer web so as to provide said multiply paperboard, wherein said first web forms a first ply, said second web forms a second ply, said third web forms a third ply, said first coating layer forms a first bonding layer and said second coating layer forms a second bonding layer of said multiply paperboard after said dewatering, and optional drying, of said multilayer web.

2. The method according to claim 1, wherein said refined CTMP or said refined CMP, or said combination thereof has a Canadian Standard Freeness (CSF) value of 300-600 ml.

3. The method according to claim 1, wherein the starch of the at least one first coating suspension comprising starch or the starch of the at least one second coating suspension comprising starch, or both comprises starch particles or mixture of starch particles and cooked starch.

4. The method according to claim 3, wherein the starch of the at least one first coating suspension comprising starch of or the starch of the at least one second coating suspension comprising starch, or both comprises starch particles of uncooked native starch.

5. The method according to claim 1, wherein said first coating layer, or said second coating layer, or both further comprises 0.1-15 g/m² microfibrillated cellulose based on a dry weight.

6. The method according to claim 1, wherein the at least one first coating suspension, or the at least one second coating suspension, or both comprises at least one further component selected from a group consisting of: rheology modifiers, cross-linkers, pH regulators, dispersing agents, biocides, defoaming agents, reinforcement agents, pigments, wood fiber fines, fillers, and dyes.

7. The method according to claim 1, wherein said at least one first coating suspension is applied to said non-wire side of said first web when said first web has a dry content of 3-20 weight-%, or said at least one second coating suspension is applied to said non-wire side of said second web or said non-wire side of said third web when said second web or said third web has a dry content of 3-20 weight-%, or both.

8. The method according to claim 1, wherein: (h) said first coating layer is applied by curtain application of at least two first coating suspensions by multilayer curtain application, or single layer curtain application at one or more curtain application stations, or both so that two or more first sub-layers are applied, said two or more first sub-layers forming said first coating layer; or
(i) said second coating layer is applied by curtain application of at least two second coating suspensions by multilayer curtain application, or single layer curtain application at one or more curtain application stations, or both so that two or more second sub-layers are applied, said two or more second sub-layers forming said second coating layer; or
both (h) and (i).

9. The method according to claim 1, wherein said first coating layer comprises 60-100% starch, based on a dry weight, or said second coating layer comprises 60-100% starch, based on a dry weight, or both.

10. The method according to claim 1, wherein said third web is joined with said second web before said first web is joined with said second web.

11. The method according to claim 1, wherein said first web consists of one first web layer, wherein said second web consists of one second web layer being said delamination layer and said third web consists of one third web layer.

12. The method according to claim 1, wherein said first web forms a top web and said first ply forms a top ply and wherein said third web forms a back web and said third ply forms a back ply.

13. The method according to claim 1, wherein said first web forms a back web and said first ply forms a back ply and wherein said third web forms a top web and said third ply forms a top ply.

14. The method according to claim 1, wherein the at least one first coating suspension, or the at least one second coating suspension, or both comprises a foam, wherein the foam is applied by said curtain application.

15. The method according to claim 1, wherein said multiply paperboard is coated with at least one barrier layer on at least one side.

16. (canceled)

17. A multiply paperboard comprising:
a first ply,
a second ply, and a
third ply,
wherein a first bonding layer is provided between said first ply and said second ply,
wherein a second bonding layer is provided between said second ply and said third ply,
wherein said second ply comprises at least one second ply layer,
wherein one second ply layer of said at least one second ply layer is a delamination layer comprising 5-80 weight-%, preferably 5-20 weight %, refined pulp based on a total dry weight of total fiber content of the second ply layer,
wherein the refined pulp is refined chemi-thermomechanical pulp (CTMP), or refined chemi-mechanical pulp (CMP), or both,
wherein said refined CTMP and said refined CMP, respectively, has a Schopper Riegler value (SR°) in the range of 20-40,
wherein said first bonding layer and said second bonding layer, respectively, comprises 0.2-20 g/m², starch based on a dry weight.

18. The multiply paperboard according to claim 17, wherein said refined CTMP, or said CMP, or both has a Canadian Standard Freeness (CSF) value of 300-600 ml.

19. The multiply paperboard according to claim 17, wherein the multiply paperboard has a Scott bond value in the range of 80-500 J/m².

20. The multiply paperboard according to claim 17, wherein the multiply paperboard has a Z-strength value in a range of 100-500 kPa.

21. The multiply paperboard according to claim 17, wherein comprising athe grammage in a range of 100-500 g/m².

22. The multiply paperboard according to claim 17, wherein the multiply paperboard is coated with at least one barrier layer on at least one side.

23. The multiply paperboard according to claim 17, wherein the multiply paperboard is or is comprised in a paperboard for liquid packaging.

24. The multiply paperboard according to claim 17, wherein the multiply paperboard is a folding box board.

25. (canceled)
